(19) United States
(12) Patent Application Publication
(10) Pub. No.: US 2009/0047462 A1
(43) Pub. Date: Feb. 19, 2009

(54) THREE-LEVEL RECORDING PHASE-CHANGE OPTICAL DISC

(75) Inventors: Chih-Hsun Lin, Taipei County (TW); Fung-Hsu Wu, Taoyuan County (TW)

Correspondence Address: J C PATENTS, INC., 4 VENTURE, SUITE 250, IRVINE, CA, 92618, US

(73) Assignee: DAXON TECHNOLOGY INC., Taoyuan County (TW)

(21) Appl. No.: 11/926,834

(22) Filed: Oct. 29, 2007

(30) Foreign Application Priority Data
Aug. 16, 2007 (TW) 96130326

(51) Int. Cl. B32B 3/02

(52) U.S. Cl. 428/64.7; 428/64.2

(57) ABSTRACT

A three-level recording phase-change optical disc including a first recording layer, a second recording layer, a third recording layer, a reflective layer, and a dielectric layer is provided. The first recording layer, the second recording layer, and the third recording layer can form three recording regions with three different reflective indexes respectively so as to increase the recording density of the optical disc.

### CROSS-REFERENCE TO RELATED APPLICATION

This application claims the priority benefit of Taiwan application serial no. 96130326, filed Aug. 16, 2007. All disclosure of the Taiwan application is incorporated herein by reference.

### BACKGROUND OF THE INVENTION

1. Field of the Invention

The present invention generally relates to an optical recording medium, in particular, to a three-level recording phase-change optical disc.

2. Description of Related Art

Compared with conventional magnetic recording medium, optical recording medium has become one of the most indispensable recording medium due to its advantages of large recording capacity, easy-to-storage property, long storage period, low manufacturing cost, and high data protection etc. With the advanced high techniques of laser photoelectric products and multimedia video/audio compression, the development of optical recording medium is going toward a bigger capacity, a higher recording density, and a smaller size.

Generally speaking, optical recording media can be categorized into compact disc (CD) and digital versatile disc (DVD), wherein DVD is currently the mainstream of optical recording media. However, with the widespread of multimedia application information, the capacity of DVD optical disc has become insufficient because most media data contain text, audio, and video data of large quantity. Accordingly, a high-density blu-ray disc (BD) which can store about 25 GB per layer by using blu-ray to write and record has been developed in order to increase the capacity of a recording medium effectively.

Among various optical recording media, the most popular one is write once recording medium (WORM), such as write once compact disc-recordable (CD-R), write once digital versatile disc-recordable (DVD-R), and write once blu-ray disc-recordable (BD-R) etc. The recording layer in such a write once optical recording medium is made of an organic dye or an inorganic material. Compared to the write once optical recording medium having its recording layer made of organic dye, the write once optical recording medium having its recording layer made of inorganic material has such advantages as simple fabrication process, low contamination, high tolerances in light and weather, etc., therefore it is one of the most potential products in optical recording medium.

Generally speaking, with different write mechanisms, recording layers made of inorganic materials of a write once optical recording medium have different material systems. For example, for a write once optical recording medium, recording points of the recording layer made of inorganic material can be formed by an alloy structure change with interface reaction of material layers or phase changes. An inorganic phase-change optical disc usually has two recording layers. While heated by a laser, the two recording layers produce phase changes so as to form a recording region, wherein the recording region can changes the reflective index of the optical disc as recording points for signal recording identification. However, only two-level reading can be achieved, therefore the recording density of the optical disc cannot be improved in foregoing inorganic phase-change optical disc.

### SUMMARY OF THE INVENTION

Therefore, the present invention provide a method of recording and reproducing information of a three-level recording phase-change optical disc, wherein three recording regions can be formed through phase changes of three different reflective indexes in recording, so that three-level reading can be achieved and accordingly the recording density of the optical disc can be improved.

The present invention provides a three-level recording phase-change optical disc including a first recording layer, a second recording layer, a third recording layer, a reflective layer, and a first dielectric layer. The second recording layer and the third recording layer are sequentially disposed on the first recording layer. The reflective layer is disposed on the third recording layer. The first dielectric layer is disposed between the reflective layer and the third recording layer. The first recording layer, the second recording layer, and the third recording layer form three recording regions.

According to embodiments of the present invention, a first recording region is formed by the first recording layer, the second recording layer, and the third recording layer; wherein the first recording region shows a first reflective index; a phase change caused by the first recording layer and the second recording layer under a first power so as to form a second recording region, and the second recording region shows a second reflective index; a phase change happened at the first recording layer, the second recording layer and the third recording layer under a second power so as to form a third recording region, and the third recording region shows a third reflective index.

According to the embodiments of the present invention, the first power is smaller than the second power.

According to the embodiments of the present invention, the first power and the second power are both between 5 mW and 30 mW.

According to the embodiments of the present invention, the differences between the first reflective index, the second reflective index, and the third reflective index have to be greater than 5%, so that a reading apparatus can distinguish these different reflective indexes.

According to the embodiments of the present invention, the material of the first recording layer may be copper (Cu) alloy.

According to the embodiments of the present invention, the material of the first recording layer may be copper (Cu)/magnesium (Mg) alloy or copper (Cu)/zinc(Zn) alloy.

According to the embodiments of the present invention, the material of the first recording layer may be copper (Cu)/silicon (Si) composition.

According to the embodiments of the present invention, the thickness of the first recording layer is between 3 nm and 10 nm.

According to the embodiments of the present invention, the material of the second recording layer may be silicon.

According to the embodiments of the present invention, the thickness of the second recording layer is between 3 nm and 10 nm.

According to the embodiments of the present invention, the material of the third recording layer may be aluminium (Al) alloy.

According to the embodiments of the present invention, the material of the third recording layer may be aluminium (Al)/zinc (Zn) alloy, aluminum(Al)/copper alloy, aluminum-titanium (Ti) alloy, or aluminum (Al)/magnesium (Mg) alloy.

According to the embodiments of the present invention, the thickness of the third recording layer is between 3 μm and 10 μm.

According to the embodiments of the present invention, the material of the first dielectric layer may be SiNₓ, ZnS—SiO₂, AlNₓ, SiC, GeNₓ, TiNₓ, TaOₓ, or YOₓ, or any compound made by more than one of SiNₓ, ZnS—SiO₂, AlN, SiC, GeNₓ, TiNₓ, TaOₓ, or YOₓ.

According to the embodiments of the present invention, the material of the reflective layer may be Ag, Au, Al, Ti, Pd, Cr, Mo, W, Ta, or an alloy containing at least one of Ag, Au, Al, Ti, Pd, Cr, Mo, W, and Ta.

According to one of the embodiments of the present invention, the three-level recording phase-change optical disc may be a digital versatile disc (DVD).

According to one of the embodiments of the present invention, the three-level recording phase-change optical disc may further include a first substrate, wherein the first recording layer is disposed on the first substrate.

According to one of the embodiments of the present invention, a second dielectric layer may be further disposed between the first substrate and the first recording layer.

According to one of the embodiments of the present invention, the material of the first substrate may be glass (SiOₓ), polycarbonate (PC), polymethylmethacrylate (PMMA), polyethylene terephthalate (PET), or polyethylene (PE).

According to one of the embodiments of the present invention, a second substrate may be further disposed on the reflective layer.

According to one of the embodiments of the present invention, the material of the second substrate may be SiOₓ, PC, PMMA, PET or PE.

According to one of the embodiments of the present invention, the three-level recording phase-change optical disc may be a blu-ray disc (BD).

According to one of the embodiments of the present invention, a substrate may be further disposed on the reflective layer.

According to one of the embodiments of the present invention, the material of the substrate may be SiOₓ, PC, PMMA, PET or PE.

According to one of the embodiments of the present invention, the three-level recording phase-change optical disc may further include a cap layer, wherein the cap layer is disposed on the first recording layer.

According to an embodiment of the present invention, a second dielectric layer may be further disposed between the cap layer and the first recording layer.

According to one of the embodiments of the present invention, the material of the cap layer may be PC.

In the present invention, three recording layers are disposed in an optical disc for recording data. While writing data into the optical disc, three recording regions having three different reflective indexes are formed in the optical disc through phase changes of the three recording layers. Accordingly, three-level reading to the optical disc can be achieved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of recording layers in a three-level recording phase-change optical disc according to an embodiment of the present invention.

FIG. 2A is a cross-sectional view of a three-level recording phase-change optical disc before any phase change is occurred according to an embodiment of the present invention.

FIG. 2B is a cross-sectional view of the three-level recording phase-change optical disc in FIG. 2A wherein the phase change is occurred at the first recording layer and the second recording layer.

FIG. 2C is a cross-sectional view of the three-level recording phase-change optical disc in FIG. 2A wherein the phase change is occurred at the first recording layer, the second recording layer, and the third recording layer.

FIG. 3 is a cross-sectional view of a three-level recording phase-change optical disc according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

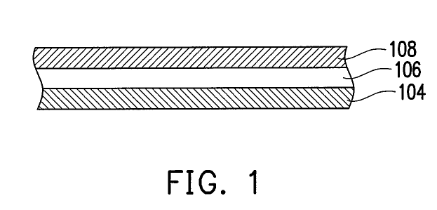

FIG. 1 is a cross-sectional view of recording layers in a three-level recording phase-change optical disc according to an embodiment of the present invention.

Referring to FIG. 1, the recoding layer in the three-level recording phase-change optical disc is composed of a first recording layer 104, a second recording layer 106, and a third recording layer 108. The second recording layer 106 and the third recording layer 108 are sequentially disposed on the first recording layer 104. The material of the first recording layer 104 may be copper alloy, and the thickness thereof is between 3 nm and 10 nm. The material of the second recording layer 106 may be silicon, and the thickness thereof is between 3 nm and 10 nm. The material of the third recording layer 108 may be aluminium alloy, and the thickness thereof is between 3 nm and 10 nm.

To be specific, the material of the first recording layer 104 may be a copper/silicon composition composed of copper and 10%˜35% of silicon, a copper/magnesium alloy composed of copper and 15%˜50% of magnesium, or a copper/zinc alloy composed of copper and 30%˜50% of zinc. The material of the third recording layer 108 may be an aluminum/copper alloy composed of aluminum and 10%˜50% of copper, an aluminum/titanium alloy composed of aluminum and 0.9%˜50% titanium, or an aluminum/magnesium alloy composed of aluminium and 30%˜50% magnesium.

The first recording layer 104, the second recording layer 106, and the third recording layer 108 can form three recording regions. When there is no phase change at the first recording layer 104, the second recording layer 106, and the third recording layer 108, a first recording region is formed and the first recording region sends back a first reflective index when the optical disc is read. When a phase change occurred at the first recording layer and the second recording layer under a first power, a second recording region is formed and the second recording region shows a second reflective index when the optical disc is read. When a phase change is occurred at the first recording layer, the second recording layer, and the third recording layer under a second power, a third recording region is formed and the third recording region shows a third reflective index when the optical disc is read. The first power and the second power are both between 5 mW and 30 mW, and the first power is smaller than the second power.

With the three different reflective indexes, three-level reading can be performed on the optical disc provided by the present invention. In addition, the three-level recording optical disc can be fabricated simply by forming the three recording layers on a substrate in sequence, namely, the optical disc can be fabricated through a well-known single-layer optical disc fabrication process therefore complex fabrication process can be avoided.

Below, a digital versatile disc (DVD) will be described as an example of the three-level recording phase-change optical disc provided by the present invention.

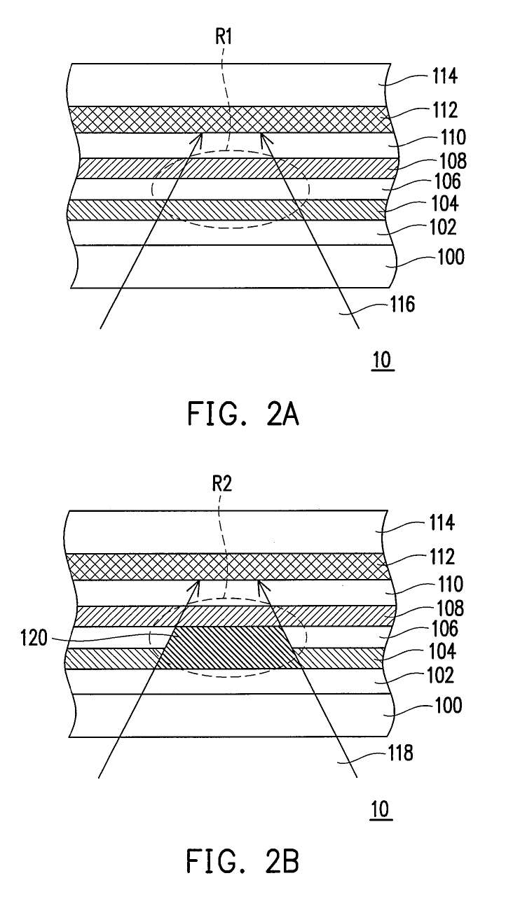

FIG. 2A is a cross-sectional view of a three-level recording phase-change optical disc according to an embodiment of the present invention. FIG. 2B is a cross-sectional view of the three-level recording phase-change optical disc for FIG. 2A, wherein a phase change occurred at the first recording layer and the second recording layer. FIG. 2C is a cross-sectional view of the three-level recording phase-change optical disc for FIG. 2A wherein a phase change occurred at the first recording layer, the second recording layer, and the third recording layer.

Referring to FIG. 2A, the optical disc 10 includes substrates 100 and 114, dielectric layers 102 and 110, a first recording layer 104, a second recording layer 106, a third recording layer 108, and a reflective layer 112.

The substrate 114 is disposed on the substrate 100. The substrate 100 includes a transparent substrate having a signal surface (with a track pitch of about 0.74 μm). The material of the substrates 100 and 114 may be glass (SiOₓ), polycarbonate (PC), polymethylmethacrylate (PMMA), polyethylene terephthalate (PET), polyethylene (PE) or other transparent materials. The thickness of the substrates 100 and 114 is about 0.6 mm.

The first recording layer 104, the second recording layer 106, and the third recording layer 108 are disposed between the substrates 100 and 114 and are sequentially disposed on the substrate 100. The material and thickness of the first recording layer 104, the second recording layer 106, and the third recording layer 108 have been described in the embodiment illustrated in FIG. 1 therefore will not be described herein.

Referring to FIG. 2A again, the reflective layer 112 is disposed between the third recording layer 108 and the substrate 114. The material of the reflective layer 112 may be Ag, Au, Al, Ti, Pd, Cr, Mo, W, Ta, or an alloy containing at least one of Ag, Au, Al, Ti, Pd, Cr, Mo, W, and Ta. The dielectric layer 102 is disposed between the substrate 100 and the first recording layer 104. The dielectric layer 110 is disposed between the reflective layer 112 and the third recording layer 108. The material of the dielectric layers 102 and 110 may be SiNₓ, ZnS—SiO₂, AlN, SiC, GeNₓ, TiNₓ, TaO, YOₓ or any compound made by more than one of SiNₓ, ZnS—SiO₂, AlN, SiC, GeNₓ, TiNₓ, TaOₓ, or YOₓ.

As shown in FIG. 2A, if a data is written into the optical disc 10 by radiating a laser 116 having a power E₀ on the optical disc 10 and the first recording layer 104, the second recording layer 106, and the third recording layer 108 do not have any phase change occurred under the power E₀, a recording region R₁ formed by the first recording layer 104, the second recording layer 106, and the third recording layer 108 sends back a reflective index r₁ by the optical disc 10 when the optical disc 10 is read. Next, as shown in FIG. 2B, if data is written into the optical disc 10 by radiating a laser 118 having a power E₁ on the optical disc 10 so that the temperature of the first recording layer 104 and the second recording layer 106 is increased to 350° C.˜450° C. under the power E₁ and accordingly an alloy layer 120 is formed at a phase change occurred by the first recording layer 104 and the second recording layer 106, a recording region R₂ formed by the alloy layer 120, and the third recording layer 108 shows a reflective index r₂ on the optical disc 10 when the optical disc 10 is read. As shown in FIG. 2C, if data is written into the optical disc 10 by radiating a laser 122 having a power E₂ on the optical disc 10 so that the temperature of the first recording layer 104, the second recording layer 106, and the third recording layer 108 is increased to 600° C.˜700° C. under the power E₂ and accordingly an ally layer 124 is formed at a phase change caused by the first recording layer 104, the second recording layer 106, and the third recording layer 108, a recording region R₃ formed by the alloy layer 124 shows a reflective index r₃ on the optical disc 10 when the optical disc 10 is read. The powers E₁ and E₂ are both between 5 mW and 30 mW, the power E₀ is smaller than the power E₁, and the power E₁ is smaller than the power E₂. The reflective indexes r₁, r₂, and r₃ are all between 10% and 60%, and the differences between the reflective indexes r₁, r₂, and r₃ are greater than 5%.

Below, a blu-ray disc (BD) will be described as an example of the three-level recording phase-change optical disc provided by the present invention. In the present embodiment, the materials of various layers are the same as those in the embodiment described above and are well-known to those having ordinary knowledge in the art, therefore will not be described herein.

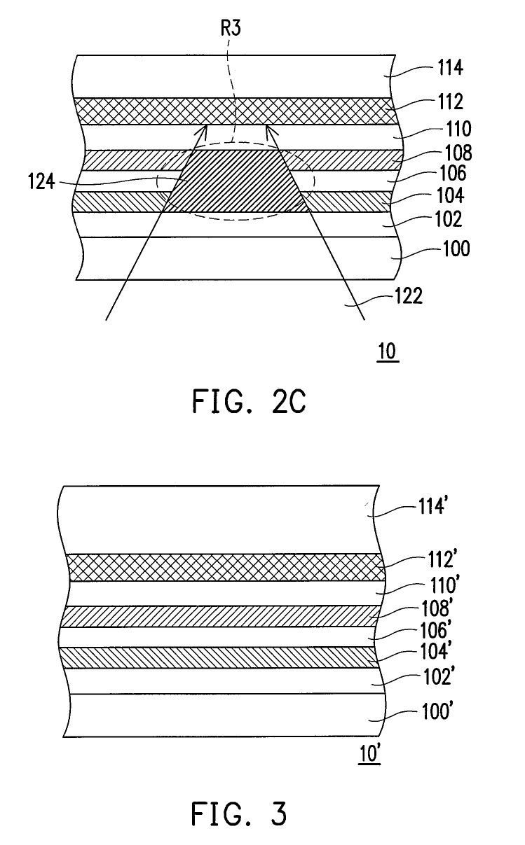

FIG. 3 is a cross-sectional view of a three-level recording phase-change optical disc according to an embodiment of the present invention.

Referring to FIG. 3, the optical disc 10′ includes a substrate 114′, a cap layer 100′, dielectric layers 102′ and 110′, a first recording layer 104′, a second recording layer 106′, a third recording layer 108′, and a reflective layer 112′.

The substrate 114′ is disposed on the cap layer 100′. The substrate 114′ includes a transparent substrate having a signal surface (with a track pitch of about 0.32 μm). The thickness of the substrate 114′ is 1.1 mm, and the thickness of the cap layer 100′ is 0.1 mm. The material of the cap layer 100′ may be PC. The third recording layer 108′, the second recording layer 106′, and the first recording layer 104′ are disposed between the substrate 114′ and the cap layer 100′ and are sequentially disposed on the substrate 114′. The reflective layer 112′ is disposed between the third recording layer 108′ and the substrate 114′. The dielectric layer 102′ is disposed between the cap layer 100′ and the first recording layer 104′. The dielectric layer 110′ is disposed between the reflective layer 112′ and the third recording layer 108′.

Similar to the optical disc 10, when data are recorded by lasers of different powers radiated onto the optical disc 10′ through the cap layer 100′, the first recording layer 104′, the second recording layer 106′, and the third recording layer 108′ can form three recording regions which show three different reflective indexes r₁′, r₂′, and r₃′ by the optical disc so that three-level reading can be achieved on the optical disc.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A three-level recording phase-change optical disc, comprising:
a first recording layer;
a second recording layer and a third recording layer, sequentially disposed on the first recording layer;
a reflective layer, disposed on the third recording layer; and
a first dielectric layer, disposed between the reflective layer and the third recording layer,
wherein the first recording layer, the second recording layer, and the third recording layer form three recording regions.

2. The three-level recording phase-change optical disc according to claim 1, wherein a first recording region is formed by the first recording layer, the second recording layer, and the third recording layer, wherein the first recording region shows a first reflective index; a phase change caused by the first recording layer and the second recording layer under a first power to form a second recording region, and the second recording region shows a second reflective index; a phase change happened at the first recording layer, the second recording layer and the third recording layer under a second power to form a third recording region, and the third recording region shows a third reflective index.

3. The three-level recording phase-change optical disc according to claim 2, wherein the first power is smaller than the second power.

4. The three-level recording phase-change optical disc according to claim 2, wherein the first power and the second power are both between 5 mW and 30 mW.

5. The three-level recording phase-change optical disc according to claim 1, wherein the material of the first recording layer comprises copper alloy.

6. The three-level recording phase-change optical disc according to claim 5, wherein the material of the first recording layer comprises copper/magnesium alloy or copper/zinc alloy.

7. The three-level recording phase-change optical disc according to claim 1, wherein the material of the first recording layer comprises copper/silicon composition.

8. The three-level recording phase-change optical disc according to claim 1, wherein the thickness of the first recording layer is between 3 μm and 10 μm.

9. The three-level recording phase-change optical disc according to claim 1, wherein the material of the second recording layer comprises silicon.

10. The three-level recording phase-change optical disc according to claim 1, wherein the thickness of the second recording layer is between 3 nm and 10 m.

11. The three-level recording phase-change optical disc according to claim 1, wherein the material of the third recording layer comprises aluminium alloy.

12. The three-level recording phase-change optical disc according to claim 11, wherein the material of the third recording layer comprises aluminium/zinc alloy, aluminum/copper alloy, aluminum/titanium alloy, or aluminum/magnesium alloy.

13. The three-level recording phase-change optical disc according to claim 1, wherein the thickness of the third recording layer is between 3 nm and 10 nm.

14. The three-level recording phase-change optical disc according to claim 1, wherein the three-level recording phase-change optical disc comprises digital versatile disc (DVD).

15. The three-level recording phase-change optical disc according to claim 14 further comprising a first substrate, wherein the first recording layer is disposed on the first substrate.

16. The three-level recording phase-change optical disc according to claim 15 further comprising a second dielectric layer disposed between the first substrate and the first recording layer.

17. The three-level recording phase-change optical disc according to claim 15, wherein the material of the first substrate comprises glass (SiOₓ), polycarbonate (PC), polymethylmethacrylate (PMMA), polyethylene terephthalate (PET) or polyethylene (PE).

18. The three-level recording phase-change optical disc according to claim 14 further comprising a second substrate disposed on the reflective layer.

19. The three-level recording phase-change optical disc according to claim 18, wherein the material of the second substrate comprises SiOₓ, PC, PMMA, PET or PE.

20. The three-level recording phase-change optical disc according to claim 1, wherein the three-level recording phase-change optical disc comprises blu-ray disc (BD).

21. The three-level recording phase-change optical disc according to claim 20 further comprising a substrate disposed on the reflective layer.

22. The three-level recording phase-change optical disc according to claim 21, wherein the material of the substrate comprises SiOₓ, PC, PMMA, PET or PE.

23. The three-level recording phase-change optical disc according to claim 20 further comprising a cap layer, wherein the cap layer is disposed on the first recording layer.

24. The three-level recording phase-change optical disc according to claim 23 further comprising a second dielectric layer disposed between the cap layer and the first recording layer.

25. The three-level recording phase-change optical disc according to claim 23, wherein the material of the cap layer comprises PC.
